(19) United States
(12) Patent Application Publication
(10) Pub. No.: US 2004/0131917 A1
(43) Pub. Date: Jul. 8, 2004

(54) End plate and method for producing same

(76) Inventors: Antonio Gennaro Mazza, Whitby (CA); David G. Frank, Scarborough (CA); Nathaniel lan Joos, Toronto (CA)

Correspondence Address: BERESKIN AND PARR, SCOTIA PLAZA, 40 KING STREET WEST-SUITE 4000 BOX 401, TORONTO, ON, M5H 3Y2, CA

(21) Appl. No.: 10/639,687

(22) Filed: Aug. 13, 2003

Related U.S. Application Data
(60) Provisional application No. 60/402,730, filed on Aug. 13, 2002.
(60) Provisional application No. 60/415,105, filed on Oct. 2, 2002.

(51) Int. Cl. H01M 8/02; B05D 5/12; B32B 15/04; B32B 9/00

(52) U.S. Cl. 429/38; 428/457; 427/115; 428/472.2

(57) ABSTRACT

The present invention provides for an end plate for an electrochemical cell. The end plate is a metal plate having at least one manifold region with at least one connection port to permit the passage of a fluid therethrough. The nd plate has a corrosion resistant coating applied to the at least one manifold region including the at least one connection port. A method for producing the end plate is also disclosed.

### RELATED APPLICATIONS

This application claims the benefit and priority from U.S. Provisional Patent Application No. 60/402,730 filed Aug. 13, 2002 and U.S. Provisional Patent Application No. 60/415,105 filed Oct. 2, 2003, the entirety of both are incorporated herein by reference.

### FIELD OF THE INVENTION

The present invention relates to an end plate for an electrochemical cell, and a method for producing same.

### BACKGROUND OF THE INVENTION

A fuel cell is an electrochemical device that produces an electromotive force by bringing the fuel (typically hydrogen) and an oxidant (typically air) into contact with two suitable electrodes and an electrolyte. A fuel, such as hydrogen gas, for example, is introduced at a first electrode where it reacts electrochemically in the presence of the electrolyte to produce electrons and cations in the first electrode. The electrons are circulated from the first electrode to a second electrode through an electrical circuit connected between the electrodes. Cations pass through the electrolyte to the second electrode. Simultaneously, an oxidant, such as oxygen or air is introduc d to the second electrode where the oxidant reacts electrochemically in the presence of the electrolyte and catalyst, producing anions and consuming the electrons circulated through the electrical circuit; the cations are consumed at the second electrode. The anions formed at the second electrode or cathode react with the cations to form a reaction product. The first electrode or anode may alternatively be referred to as a fuel or oxidizing electrode, and the second electrode may alternatively be referred to as an oxidant or reducing electrode. The half-cell reactions at the two electrodes are, respectively, as follows:

H₂→2H⁺+2e⁻

½O₂+2H⁺+2e⁻→H₂O

The external electrical circuit withdraws electrical current and thus receives electrical power from the fuel cell. The overall fuel cell reaction produces electrical energy as shown by the sum of the separate half-cell reactions written above. Water and heat are typical by-products of the reaction.

In practice, fuel cells are not operated as single units. Rather, fuel cells are connected in series, stacked one on top of the other, or placed side by side, to form what is usually referred to as a fuel cell stack. Th fuel and oxidant are directed through manifolds to the electrodes, while cooling is provided either by the reactants or by a cooling medium. Also within the stack are current collectors, cell-to-cell seals and insulation, with required piping and instrumentation provided externally of the fuel cell stack. The stack and associated hardware make up a fuel cell unit or module.

A fuel cell stack is completed by two end plates provided on opposite ends of the stack. End plates provide connection between the internal flow channels of the stack and external sources of process fluids (e.g., fuel, oxidant and coolant). End plates are usually provided with connection ports for this purpose. Process fluids flow through respective connection ports into and out of the fuel cells stack. Since process fluids and coolant (e.g., deionized water) are usually corrosive, at least part of the surface of the connection ports on the end plates, through which process fluids flow, are in constant contact with highly corrosive acidic solutions (pH between about 3.5 to about 4.5), containing CO₃²⁻, HCO₃⁻, HSO₄⁻, SO₄²⁻, etc.

Stainless steel is typically used to manufacture conventional end plates. However, stainless steel is heavy and susceptible to attack by the process fluids and/or coolant. This can result in the dissolution of ferrous ions into the process fluids, which can cause contamination of the process fluids. Meanwhile, corrosion of the end plates may lead to leakage and even destruction of the electrochemical cell stack.

### SUMMARY OF THE INVENTION

The present invention provides for an end plate for an electrochemical cell, comprising:

a) a metal plate having a manifold region with a connection port to permit the passage of a fluid therethrough; and

b) a corrosion resistant coating applied to at least a portion of the manifold region including the connection port.

In one aspect of the invention, the connection port is defined by at least one wall and the corrosion resistant coating is applied to the at least one wall.

In another aspect of the invention, the metal plate is made from a metal selected from the group consisting of aluminum and aluminum alloys.

In another aspect of the invention, the corrosion resistant coating is an anodized aluminum coating.

In another aspect of the invention, the corrosion resistant coating is a hard coat anodized aluminum coating.

In another aspect of the invention, the hard coat anodized aluminum coating has a plurality of pores and is treated to seal at least a portion of the pores.

In another aspect of the invention, the hard coat anodized aluminum coating has a thickness of between about 3 μm to about 130 μm.

In another aspect of the invention, the corrosion resistant coating is a conformal coating.

In another aspect of the invention, the conformal coating is a polymer material selected from the group consisting of silicone resins, acrylic resins, polyurethane resins, epoxy resins, polytetrafluoroethylene, polyvinylidenefluoride, and poly para-xylene.

In another aspect of the invention, the conformal coating is poly para-xylene.

In another aspect of th invention, the conformal coating has a thickness of between about 0.05 μm to about 150 μm.

In another aspect of the invention, the corrosion resistant coating is applied to essentially all of the exposed surfaces of the manifold region.

In another aspect of the invention, the corrosion resistant coating is applied to essentially all of the exposed surfaces of the end plate.

The present invention also provides for a method of producing an end plate for an electrochemical cell, comprising;

a) providing a metal plate having a manifold region with a connection port to permit the passage of a fluid therethrough; and

b) applying a corrosion resistant coating to at least a portion of the manifold region including the connection port.

In one aspect of the invention, the connection port is defined by at least one wall and the corrosion resistant coating is applied to the at least the wall.

In another aspect of the invention, the method further comprises forming the metal plate from one of aluminum and an aluminum alloy.

In another aspect of the invention, the method further comprises selecting an anodized aluminum coating as the corrosion resistant coating.

In another aspect of the invention, step (b) is performed by subjecting at least a portion of the manifold region to a process selected from the group consisting of chromic acid anodizing, low voltage chromic anodizing, anodizing in a non-chromic acid electrolyte, sulfuric acid anodizing and hard coat anodizing to apply the anodized aluminum coating.

In another aspect of the invention, step (b) is performed by subjecting at least a portion of the manifold region to a hard coat anodizing process to apply a hard coat anodized aluminum coating having a plurality of pores.

In another aspect of the invention, the method further comprises the step of subjecting at least a portion of the manifold region to a sealing treatment after step (b) to seal at least a portion of the pores.

In another aspect of the invention, the sealing treatment is selected from the group consisting of dichromate sealing, potassium dichromate sealing, boiling water sealing, and triethanolamine sealing.

In another aspect of the invention, the method further comprises the step of subjecting the manifold region to a mechanical process prior to step (b) to remove sharp edges and/or to round corners.

In another aspect of the invention, the mechanical process comprises radiusing.

In another aspect of the invention, step (b) is practiced to apply an anodized aluminum coating having a thickness of between about 3 μm to about 130 μm.

In another aspect of the invention, the method further comprises selecting a conformal coating as the corrosion resistant coating.

In another aspect of the invention, the conformal coating is a polymer material selected from the group consisting of silicone resins, acrylic resins, polyurethane resins, epoxy resins, polytetrafluoroethylene, polyvinylidenefluoride, and poly para-xylene.

In another aspect of the invention, the conformal coating is poly para-xylene.

In another aspect of the invention, step (b) is performed by subjecting at least a portion of the at least one manifold region to a vacuum deposition process to apply the poly para-xylylene.

In another aspect of the invention, the method further comprises the step of subjecting the manifold region to a mechanical process prior to step (b) to remove sharp edges and/or to round corners.

In another aspect of the invention, the mechanical process comprises radiusing.

In another aspect of the invention, step (b) is practiced to apply a conformal coating having a thickness of between about 0.05 μm to about 150 μm.

In another aspect of the invention, step (b) is practiced to apply the corrosion resistant coating to essentially all of the exposed surfaces of the manifold region.

In another aspect of the invention, step (b) is practiced to apply the corrosion resistant coating to essentially all of the exposed surfaces of the end plate.

Other features and advantages of the present invention will become apparent from the following detailed description. However, it should be understood, that the detailed description and the specific examples while indicating preferred embodiments of the invention are given by way of illustration only, since various changes and modifications within the spirit and scope of the invention will become apparent to those skilled in the art from this detailed description.

### BRIEF DESCRIPTION OF THE DRAWINGS

For a better understanding of the present invention, and to show more clearly how it may be carried into effect, reference will now be made, by way of example, to the accompanying drawings, which show a pref rred embodiment of the present invention and in which:

FIG. 1 shows an exploded perspective view of a fuel cell stack;

FIG. 2a shows a perspective view of a front face of a conventional end plate;

FIG. 2b shows a perspective view of a rear face of the conventional end plate of FIG. 2a;

FIG. 3 shows a perspective view of a rear face of an end plate according to a first embodiment of the present invention;

FIG. 4 shows a perspective view a front face of the end plate of FIG. 3;

FIG. 5 shows a schematic view of the front face of the end plate of FIG. 4;

FIG. 6 shows a cross-sectional view of the end plate taken along line A-A of FIG. 5;

FIG. 7 shows a cross-sectional view of the end plate taken along line B-B of FIG. 5;

FIG. 8 shows a perspective view of a rear face of an end plate according to a second embodiment of the present invention;

FIG. 9 shows a perspective view of a front face of the end plate of FIG. 8;

FIG. 10 shows a perspective view of a rear face of an end plate according to a third embodiment of the present invention;

FIG. 11 shows a perspective view of a front face of the end plate of FIG. 10;

FIG. 12 shows an exploded perspective view of a fuel cell stack;

FIG. 13 shows a Polarization Resistance Scan of a hard coat anodized aluminum sample;

FIG. 14 shows a Tafel Scan of a hard coat anodized aluminum sample;

FIG. 15 shows an Electrochemical Impedance Spectroscopy (EIS) Scan of a hard coat anodized aluminum sample; and

FIG. 16 shows a Potentiostatic EIS Nyquist Plot of a hard coat anodized aluminum sample.

### DETAILED DESCRIPTION OF THE INVENTION

The present invention relates to an end plate for an electrochemical cell. Hereinafter, the present invention will be described in detail by taking a PEM fuel cell as an example. It is to be understood that the present invention has applications not limited to PEM fuel cells, but rather any type of electrochemical cells, such as electrolyzers.

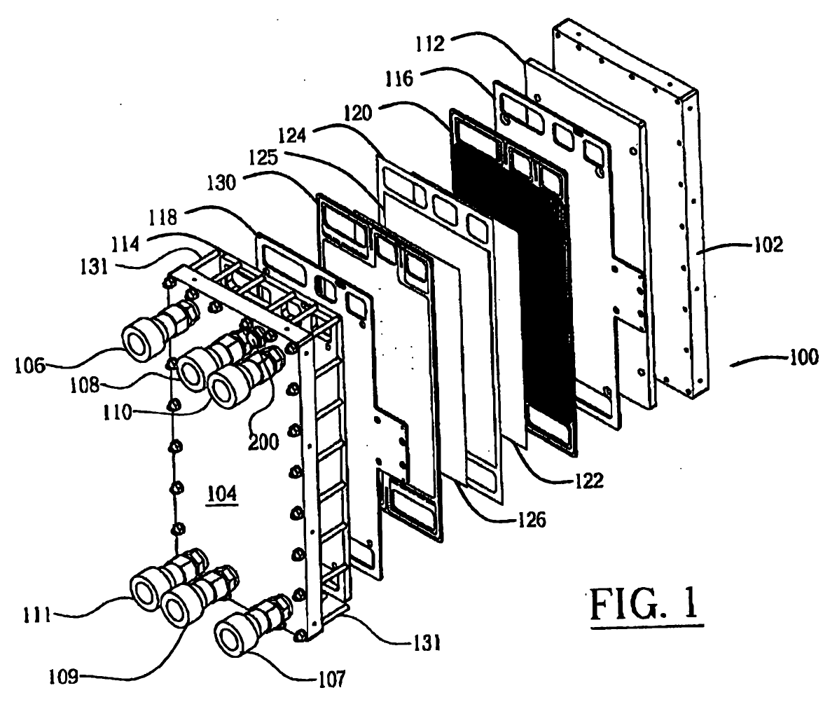

Referring first to FIG. 1, this shows an exploded perspective view of a fuel cell stack according to the present invention. It is to be understood that while a single fuel cell unit is detailed below, in known manner the fuel cell stack will usually comprise a plurality of fuel cells stacked together. By way of example only, FIG. 1 relates to a fuel cell stack that is designed to operate in a ‘closed-end’ mode (e.g., the process fluids and the coolant are supplied to and discharged from the same end of the fuel cell stack). In this design, there is a first end plate 102 that does not come into contact with process fluids and coolant and a second end plate 104 that does come into contact with process fluids and coolant.

However, it is to be understood that a fuel cell stack can also be designed to operate in a ‘flow-through’ mode (e.g., the process fluids and the coolant are supplied to the fuel cell stack at one end and discharged from the fuel cell stack from the opposite end thereof). In this design, all of the different types of plates employed in the fuel cell stack must have manifold regions with corresponding inlets and outlets to allow for process fluids and coolant to pass therethrough. Accordingly, in this design both the first end plate 102 and the second end plate 104 would be provided with manifold regions having connection ports to allow the process fluids and coolant to pass therethrough.

Each fuel cell unit in the fuel cell stack comprises an anode flow field plate 120, a cathode flow field plate 130, and a membrane electrode assembly (MEA) 124 disposed between the anode and cathode flow field plat s 120, 130. Each reactant flow field plate has an inlet region, an outlet region, and op n-faced channels to fluidly connect the inlet to the outlet, and provide a way for distributing the reactant gases to the outer surfaces of the MEA 124. The MEA 124 comprises a solid electrolyte (e.g., a proton exchange membrane or PEM) 125 disposed between an anode catalyst layer (not shown) and a cathode catalyst layer (not shown). A first gas diffusion layer (GDL) 122 is disposed between the anode catalyst layer and the anode flow field plate 120, and a second GDL 126 is disposed between the cathode catalyst layer and the cathode flow field plate 130 The GDLs 122, 123 facilitate the diffusion of the reactant gas, either the fuel or oxidant, to the catalyst surfaces of the MEA 124. Furthermore, the GDLs enhance the electrical conductivity between each of the anode and cathode flow field plates 120, 130 and the membrane 125.

In a catalyzed reaction, a fuel such as pure hydrogen, is oxidized at the anode catalyst layer of the MEA 124 to form protons and electrons. The proton exchange membrane 125 facilitates migration of the protons from the anode catalyst layer to the cathode catalyst layer. The electrons cannot pass through the proton exchange membrane 125, and are forced to flow through an external circuit (not shown), thus providing an electrical current. At the cathode catalyst layer of the MEA 124, oxygen reacts with electrons returned from the electrical circuit to form anions. The anions formed at the cathode catalyst layer of the MEA 124 react with the protons that have crossed the membrane 125 to form liquid water as the reaction product.

Still referring to FIG. 1, hereinafter the designations “front” and “rear” with respect to each and every plate within the fuel cell stack indicate their orientation with respect to the MEA 124. Thus, the “front” face indicates the side facing towards the MEA 124, while the “rear” face indicates the side facing away from the MEA 124.

A first current collector plate 116 abuts against the rear face of th anod flow field plate 120. Similarly, a second current collector plate 118 abuts against the rear face of the cathode flow field plate 130. First and second insulator plates 112, 114 are located imm diately adjac nt the first and second current collector plates 116, 118, respectively. First and second end plates 102, 104 are located immediately adjacent the first and second insulator plates 112, 114, respectively. Pressure may be applied on the end plates 102, 104 to press the unit 100 together. Moreover, sealing means are usually provided between each pair of adjacent plates. Preferably, a plurality of tie rods 131 may also be provided. The tie rods 131 are screwed into threaded bores in the cathode endplate 104, and pass through corresponding plain bores in the anode endplate 102. In known manner, fastening means, such as nuts, bolts, washers and the like are provided for clamping together the fuel cell unit 100 and the entire fuel cell stack.

Still referring to FIG. 1, the second endplate 104 is provided with a plurality of fittings for the supply of various fluids. Specifically, the second endplate 104 has first and a second air fittings 106, 107, first and second coolant fittings 108, 109, and first and second hydrogen fittings 110, 111. As will be understood by those skilled in the art, the MEA 124, the anode and cathode flow field plates 120, 130, the first and second current coll ctor plates 116, 118, the first and second insulator plates 112, 114, and the first and/or second end plates 102, 104 have apertures one end and three apertures near the opposite end thereof, which are in alignment to form fluid flow paths for air as an oxidant, a coolant, and hydrogen as a fuel. By way of example only, FIG. 1 shows a fuel cell stack designed to have the process fluids flow counter-currently in the fuel cell stack. It is appreciated that the stack can be designed to have the process fluids flow co-currently through the fuel cell stack. Although not shown, it will be understood that the various fittings 106-111 are fluidly connected to ducts that extend along the length of the fuel cell unit.

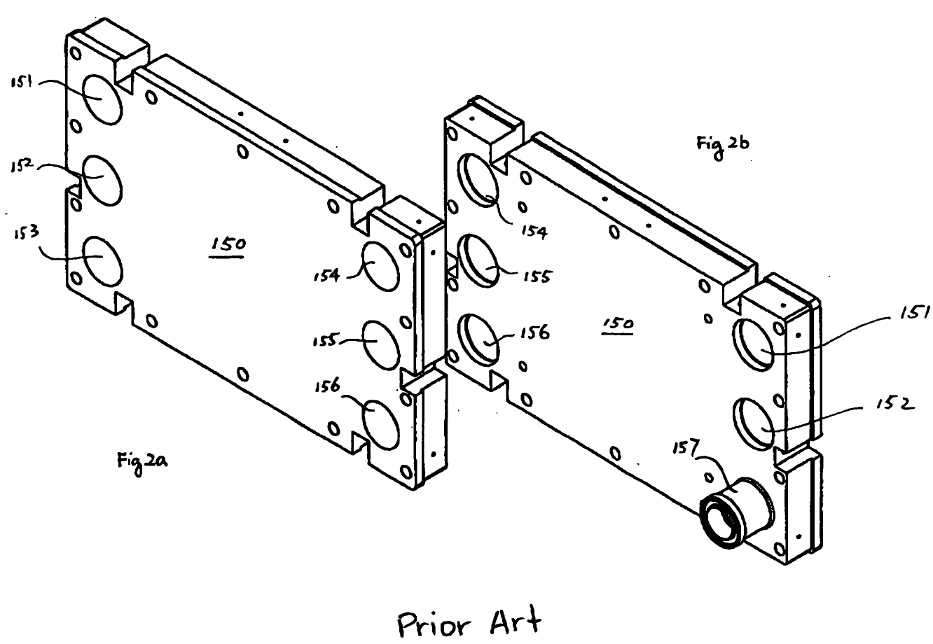

Referring now to FIGS. 2a and 2b, a conventional end plate is shown generally at 150. The end plate 150 is provided with three connection ports 151-153 near one end and three connection ports 154-156 near the opposite end thereof. As described above, these connection ports are used to conn ct to external sources of process fluids and preferably align with the ducts formed within the stack by apertures of reactant flow field plates. Conventional end plates are typically made of stainless steel. However, it is still subjected to corrosion of process fluids in the area of the connection ports. Hence, the fittings can be made of a corrosion resistant material, for example, aluminum or an aluminum alloy, and can be provided in each of the connection ports 151-156, In FIG. 2b, only one such fitting 157 is shown for simplicity. The aluminum fitting 157 connects to the connection port 153 via a threaded connection (not shown). However, this still cannot completely overcome the corrosion problem. The fitting 157 has to be fully screwed into the connection port 156 to prevent the stainless steel surface from being exposed to process fluids. However, when a fuel cell stack is assembled, the fitting 157 should not protrude from the front face of the end plate 150. This complicates the assembly of the fuel cell stack while hardly alleviates the corrosion problem. Furthermore, aluminum and aluminum alloys are also subject to corrosive attack by process fluids.

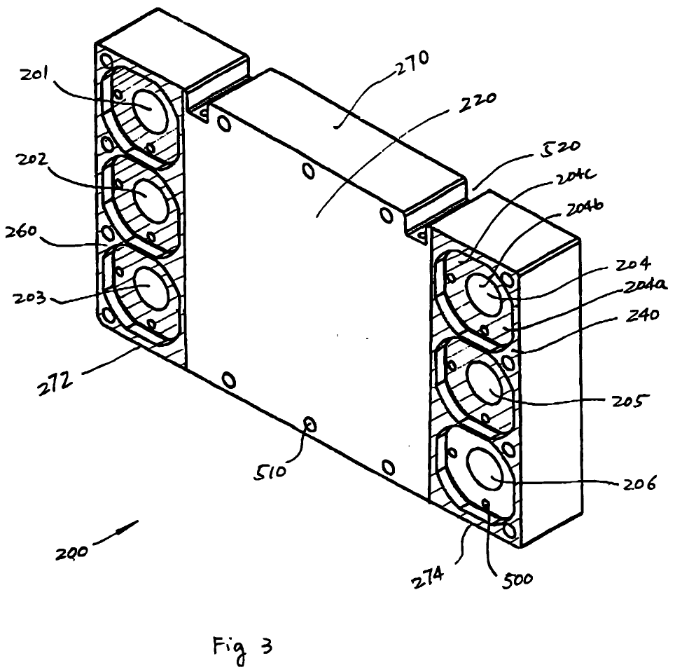

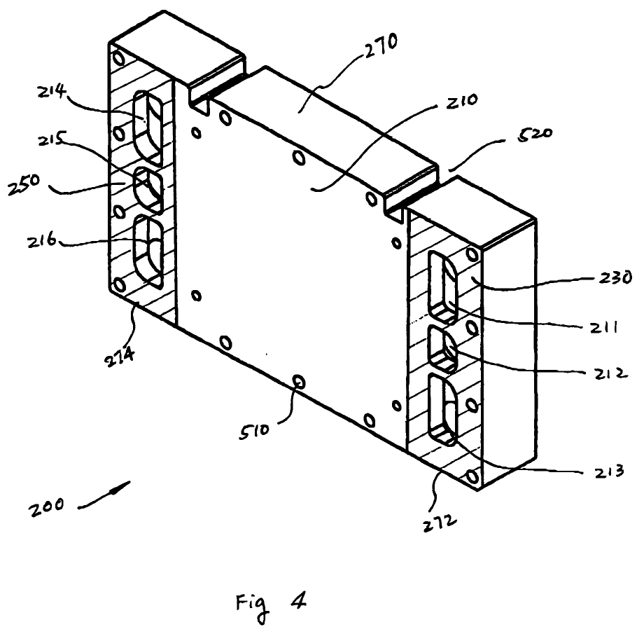

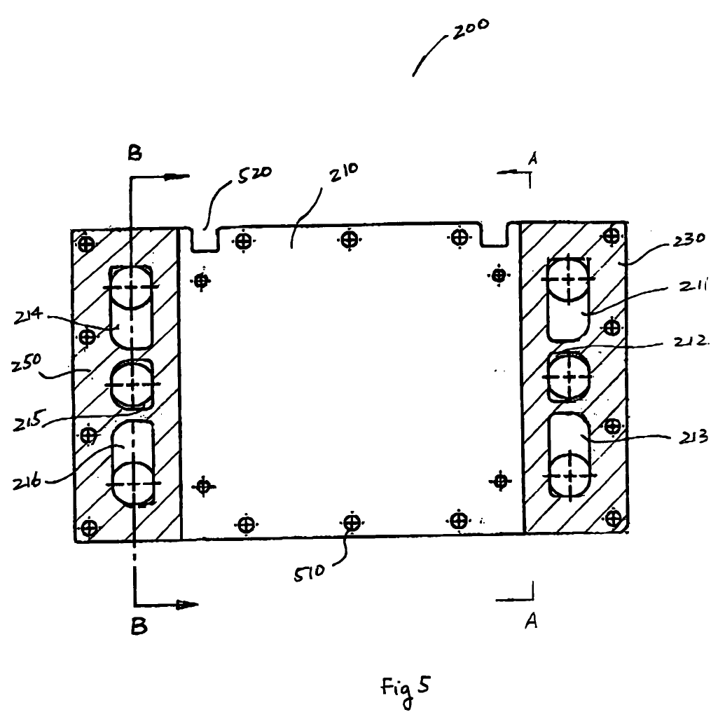

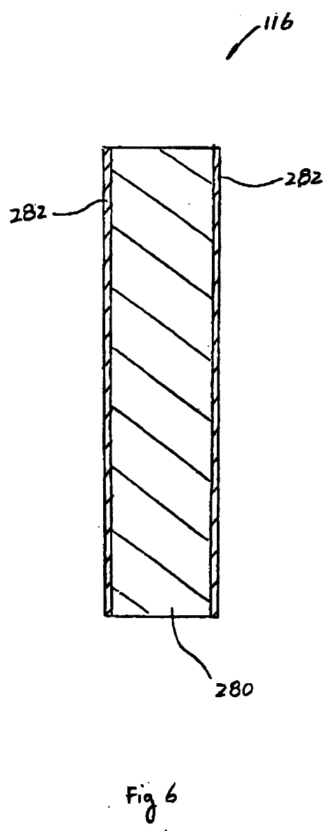

FIGS. 3-7 illustrate a first embodiment of an end plate 200 according to the present invention. The end plate 200 has a central region 270, a first manifold region 272 on one end and a second manifold region 274 on the opposite end. On a rear face 220 of the end plate 200, three connection ports 201, 202 and 203 are provided on the rear face 260 of the first manifold region 272 and three connection ports 204, 205 and 206 are provided on the rear face 240 of the second manifold region 274 (see FIG. 3). On the front face 210 of the end plate 220, three connection ports 211, 212 and 213 are provided on the front face 230 of the first manifold region 272 and three connection ports 214, 215 and 216 are provided on the front face 250 of the second manifold region 274 (see FIGS. 4 and 5). The connection ports 201-206 fluidly communicate with connection ports 211-216 respectively to allow respective process fluids to flow from rear face 220 towards the front face 210. Again, various connections ports 201-206 align with internal ducts extending throughout the length of the fuel cell stack to distribute process fluids within the fuel cell stack.

The connection ports 201-206 and 211-216 can take various shapes or forms. In this embodiment, on the front face 210, the conn ction ports 211-216 are shaped such that they match the shape of the inlet and outlet apertures of the adjacent plate within the fuel cell stack to minimize leakage of the process fluids (see FIG. 4). On the rear face 220, each of the connection ports 201-206, for example, connection port 204, has a counter bore 204a with an enlarged diameter and an inner bore 204b with a reduced diameter. The inner bore 204b fluidly communicates with the corresponding connection port 214 provided on the front face 210 of the end plate 200. As can be seen in FIG. 5, the inner bore 204b has a diameter substantially equal to the diameter of the corresponding connection port 214. On the bottom face 204c of the counter bore 204a, a plurality of threaded holes 500 are provided. Threaded holes 500 are also provided on the bottom face of the counter bore of each connection port on the rear face 220 for connection to external ducts or hoses. The end plate 200 is also provided with a plurality of threaded holes 510 around its periphery for connection with tie rods (not shown) for clamping the stack together. In the embodiment, these threaded holes are through holes. However, they can also be blind holes. To facilitate alignment of the fuel cell stack, the end plate 200 is provided on the side at least one notch 520 through which alignment means can be inserted during assembly to prevent the end plate 200 from moving.

The end plate 200 comprises a metal plate 280. In a preferred embodiment, the metal plate 280 is made of a metal selected from the group consisting of aluminum and aluminum alloys. Aluminum is a good electrical conductor, is lightweight and is relatively inexpensive. In one aspect of the invention, the metal plate 250 is formed from an aluminum alloy 6061, whose nominal composition includes: 0.25% Cu, 0.6% Si, 0.15% Mn, 1.0% Mg, 0.25% Cr, 0.25% Zn, 0.7% Fe and 0.15% Ti.

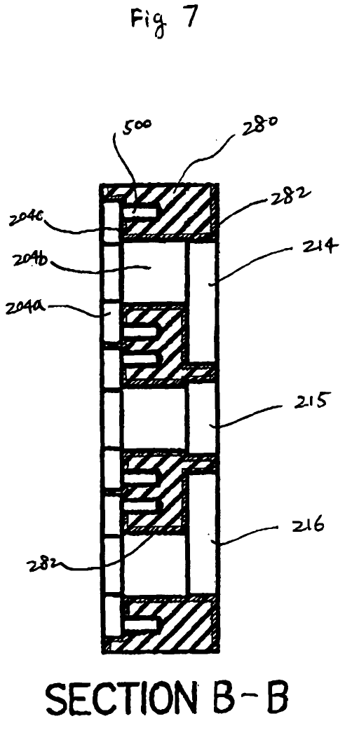

In the present invention, at least the surfaces of the end plate 200 exposed to process fluids are treated with an anodized aluminum coating 282. The anodized aluminum coating provides corrosion resistance and also passivates the coated ar as and renders the first and second manifold regions substantially electrically non-conductive. Specifically, at least the inner walls of the connection ports 201-206 and 211-216 are coated with the anodized aluminum coating (see FIG. 7). To ensure that possible leakage of the process fluids does not corrode the metal plate 280 around the connection ports 201-206 and 211-216, the front face around the connection ports 211-216, the rear face around the connection ports 201-206 as well as the side surfaces and bottom surfaces of the counter bores 201a, 202a, etc. are also preferably provided with the anodized aluminum coating 282. The treated faces can be extended to even further areas. In this embodiment, as shown in FIGS. 3-5, this anodized aluminum coating is applied on the rear and front faces 230, 240, 250 and 260 of both the first and second manifold regions 272 and 274 (e.g., areas adjacent the connection ports for process fluids). For simplicity, FIGS. 3-5 show the demarcations between the central region 270 and the first and second manifold regions 272 and 274 are straight lines. However, it is understood that the demarcations can be in any shape and depends on the mask material used to cover the areas not intended for coating during the coating process.

The anodized aluminum coating 282 can be applied onto the first and second manifold regions 272, 274 using any anodizing method known in the art, including, but not limited to, chromic acid anodizing, low voltage chromic acid anodizing, anodizing in non-chromic acid electrolyt sulfuric acid anodizing, and hard coat anodizing.

In a particularly preferred embodiment, the anodized aluminum coating 282 is applied using a hard coat anodizing process. The resulting hard coat anodized aluminum coating penetrates into the base metal plate 280 and subsequently builds up on the surface of the metal plate 280. The thickness of the anodized aluminum coating includes both the penetration into the base metal and the build-up on the surface. The thickness of the hard coat anodized aluminum coating can be applied to between about 3 μm to about 130 μm, more preferably between about 25 μm to about 75 μm, and most pref rably about 50 μm (e.g., the hard coat anodized aluminum coating extends into the metal plate 350 about 25 μm and beyond the surface of the metal plate 350 about 25 μm).

In a particularly preferred aspect of the invention, the first and second manifold regions 272, 274 are treated with hard coat anodizing followed by a sealing treatment. The sealing treatment can be achieved by any well known method in the art, including, but not limited to, dichromate bath, potassium dichromate bath, boiling water sealing and triethanolamin sealing. This treatment seals the pores of the hard coat anodized aluminum coating on the first and second manifold regions 272, 274 and provides further protection against corrosion.

In a particularly preferred aspect of the invention, prior to subjecting the first and second manifold regions 272, 274 to the anodizing process, the first and second manifold regions 272, 274 can be surface treated to minimize the occurrence of sharp edges and/or to round corners to obtain a more uniform anodized aluminum coating around the edges and/or corners. This can be achieved by any mechanical process well known in the art, including, but not limited to, radiusing.

In one aspect of the invention, the central region 270 is first masked and the anodized aluminum coating 282 is subsequently applied to the first and second manifold regions 272, 274.

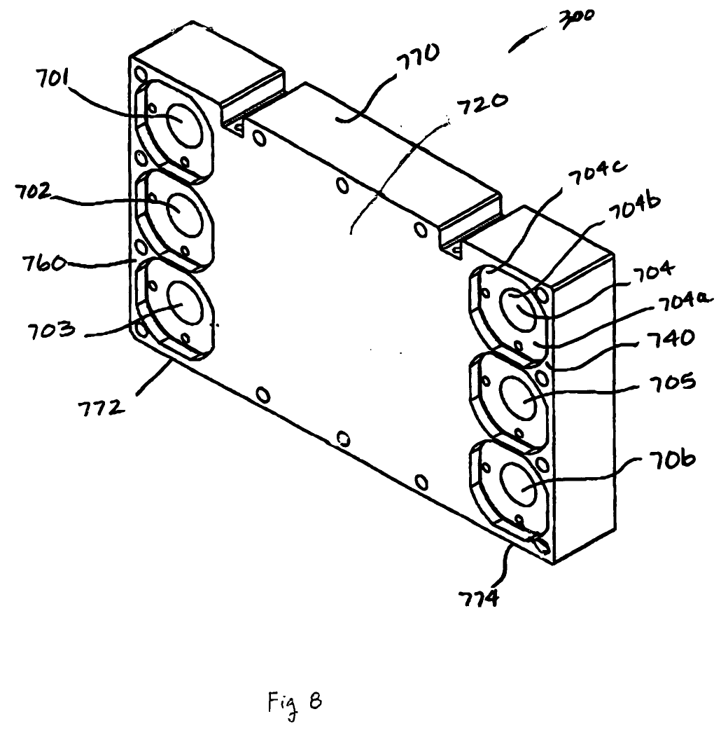

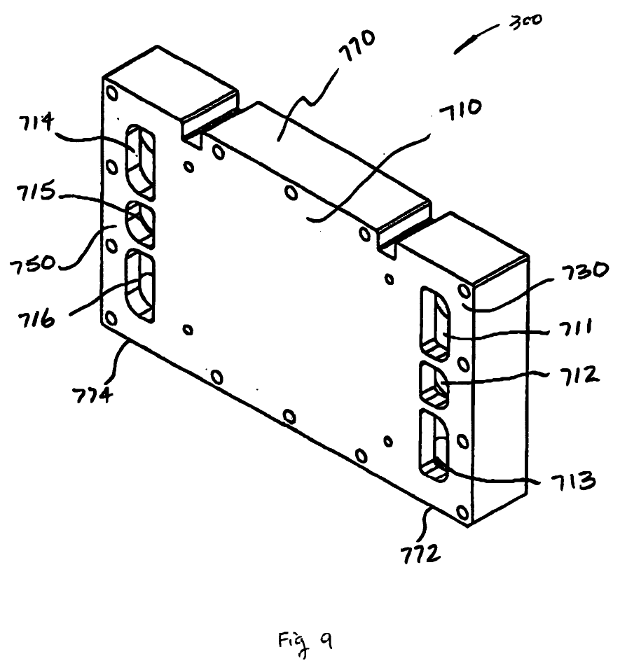

Now referring to FIGS. 8 and 9, an end plate according to a second embodiment of the present invention is shown generally at 700. In this embodiment, like parts have been designated by the same reference numeral with the prefix “7” and only differences are discussed.

The end plate 700 comprises a metal plate 780. The metal plate 780 can be made of a metal including, but not limited to, aluminum magnesium, beryllium, titanium, copper, stainless steel and any alloys thereof Preferably, th metal plate 780 is made of aluminum or an aluminum alloy.

In the present inv ntion, at least the surfaces of the end plate 700 exposed to process fluids are treated with a conformal coating 782. The conformal coating provides corrosion resistance and also passivates the coated areas and renders the first and second manifold regions substantially electrically non-conductive. Specifically, at least the inner walls of the connection ports 701-706 and 711-716 are coated with the conformal coating. To ensure that possible leakage of the process fluids does not corrode the metal plate 780 around the connection ports 701-706 and 711-716, the front face around the connection ports 711-716, the rear face around the connection ports 701-706 as well as the side surfaces and bottom surfaces of the counter bores 701a, 702a, etc. are also preferably provided with the conformal coating 782. The treated faces can be extended to even further areas. In this embodiment, as shown in FIGS. 8 and 9, the conformal coating is applied on the rear and front faces 730, 740, 750 and 760 of both the first and second manifold regions 772 and 774 (e.g., areas adjacent the connection ports for process fluids). For simplicity, FIGS. 8 and 9 show the demarcations between the central region 770 and the first and second manifold regions 772 and 774 are straight lines. However, it is understood that the demarcations can be in any shape and depends on the mask material used to cover the areas not intended for coating during the coating process.

This conformal coating 782 can be applied onto the first and second manifold regions 772 and 774 using any method well known in the art. Examples of these methods include, but are not limited to, spraying, chemical vapor deposition, laser augmentation, plasma spraying, thermal deposition, vacuum coating, electrostatic spraying. It will be appreciated that the choice of application method will depend on the type of conformal coating selected.

Conformal coatings 782 will, on application to a surface, conform to the surface features of a metal plate including, but not limited to, sharp edges, corners and flat exposed internal surfaces. Conformal coatings 554 tend to exhibit the following properties: (i) high diel ctric strength; (ii) chemical resistant; (iii) abrasion resistant; (vi) substantially pore-free; (v) substantially impervious to fluids; (vi) relatively stable; (vii) substantially electrically non-conductive.

The conformal coating is preferably made of a polymer material selected from the group consisting of: (i) silicone resins (e.g., Fine-L-Kote™ HT high temperature coating which is applied as a spray and is available from Techspray™ or Fine-L-Kote™ SR silicone conformal coating which is applied as a spray and is available from Techspray™); (ii) acrylic resins (e.g., Fine-L-Kote™ AR acrylic conformal coating which is applied as a spray and is available from Techspray™) (iii) polyurethane resins (e.g., Fine-L-Kote™ UR which is applied as a spray and is available from Techspray™) (iv) epoxy resins (e.g., Scotchkote™ 134 Fusion Bonded Epoxy Coating which is a heal curable thermosetting epoxy coating available from 3M™); (v) polytetrafluoroethylene (PTFE) (e.g., Teflon™ available from Dupont); (vi) polyvinylidenefluoride (PVDF) (e.g., Kynar™ available from Atofina Chemicals); and (vii) poly para-xylene (e.g., which is commonly referred to as Parlyene and is available from Parlyene Coating Services Inc.).

Preferably, the conformal coating 782 is a poly para-xylene. Poly para-xylene is available in three different variations, including poly para-xylene C (low permeability to moisture, chemicals and other corrosive gases), poly para-xylene N (high dielectric strength and a dielectric constant that does not vary with changes in frequency), and poly para-xylene D (maintains physical strength and electrical properties at high temperatures). Poly para-xylene is preferably applied using a vacuum deposition process as is well known in the art.

In a particularly preferred aspect of the invention, prior to applying the coating to the manifold region, the manifold region can be surface treated to minimize the occurrence of sharp edges and/or to round corners to obtain a more uniform conformal coating around the edges and/or corners. This can b achieved by any mechanical process well known in the art, including, but not limited to, radiusing.

In one aspect of the invention, the central region 770 is first masked and the conformal coating 782 is subsequently applied to the first and second manifold regions 772, 774. The thickness of the conformal coating is between about 0.05 μm to about 150 μm, more preferably between about 25 μm to about 75 μm, and most preferably about 25 μm.

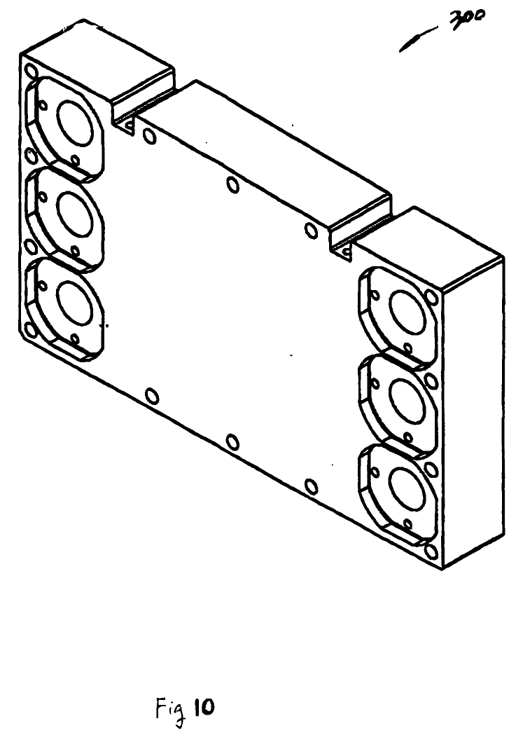

FIGS. 9 and 10 illustrate a third embodiment of an end plate 300 according to the present invention. In this embodiment, the only difference is that all of the surfaces of the end plate 300 are treated with a corrosion resistant coating (e.g., a hard anodized coating sealed with a sealing treatment or a conformal coating). For simplicity, no shadings are used in FIGS. 9 and 10 to indicate the coated surfaces. Further, description of the structure of the end plate is not repeated herein. It is to be understood that although the cost of materials may be higher than that in the first and second embodiments because of the larger area to be coated, the overall coating process may be relatively simpler since no masking issues are involved. Further, the appearance of the end plate is more aesthetically pleasing and the risk of surface corrosion of the endplates from exposure to its operating environment is minimized.

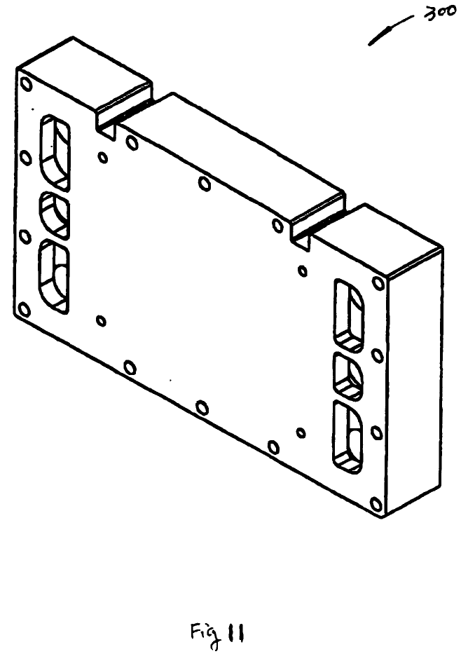

Now reference will be made to FIG. 11, which shows an exploded perspective view of a fuel cell stack 600 incorporating an end plate according to the present invention. Fittings 400 are mounted onto the connection ports on the rear face of the end plate. The fittings have a flange portion 420 that engages the bottom face of each connection port. Through holes 440 are provided on the flange portion 420 in correspondence with the threaded holes 500 on the end plate so that screws can be used to fixed the fittings thereon. The fittings 400 have a bore 460 that provides a flow path for the process fluids. Different fittings can be used, as shown in FIG. 11 to further connect to an external duct or hose that supplies process fluids to the fuel cell stack 600. These fittings can be commercially availabl off-the-shelf parts. However, these fittings are preferably also corrosion resistant in order to obtain the best anti-corrosion results. For example, plastic fittings can be used for this purpose.

The present invention has been described by way of example. It is to be noted that the design of the flow field plates and other plates do not form part of the present invention. The shape and arrangement of the various plates within the fuel cell stack are not limited to those disclosed in the above embodiment. The shape of the end plate is also not limited to that shown in the accompanying figures. F or example, the end plate can be circular, oval and any other shape as desired. Moreover, the shape of connection ports can vary. It is also to be understood that the present invention is also applicable to end plates of other electrochemical cells, including, but not limited to, electrolyzers.

The invention will be more fully understood by reference to the following examples. However, the examples are merely intended to illustrate embodiments of the invention and are not to be construed to limit the scope of the invention.

### EXAMPLE 1

Samples of aluminum coupons having a hard coat anodized aluminum coating were prepared in accordance with the present invention. Specifically, the aluminum coupons were subjected to a hard coat anodizing process to form a porous hard coat anodized aluminum coating having a thickness of about 50 μm. Subsequently, the samples were sealed in a 5% dichromate solution.

Various electrochemical corrosion tests were conducted to determine the nature and corrosion behavior of the hard coat anodized aluminum coatings. Polarisation resistance measurements were taken and a Tafel analysis was conducted to characterize the corrosion behavior of the hard coat anodized coatings. Electrochemical Impedance Spectroscopy (EIS) was also us d to determine the electrochemical nature of the hard coat anodized coating.

The samples were immersed for each of the tests in a simulated fuel cell environment solution consisting of sulphuric acid at 10-4 moles/liter and a fluoride ion concentration of 2 parts per million. During the tests, the test cells were maintained at 60° C. by immersion in a circulating water bath. A Gamry TM PC4/750 potentiostat was used to carry out the analysis.

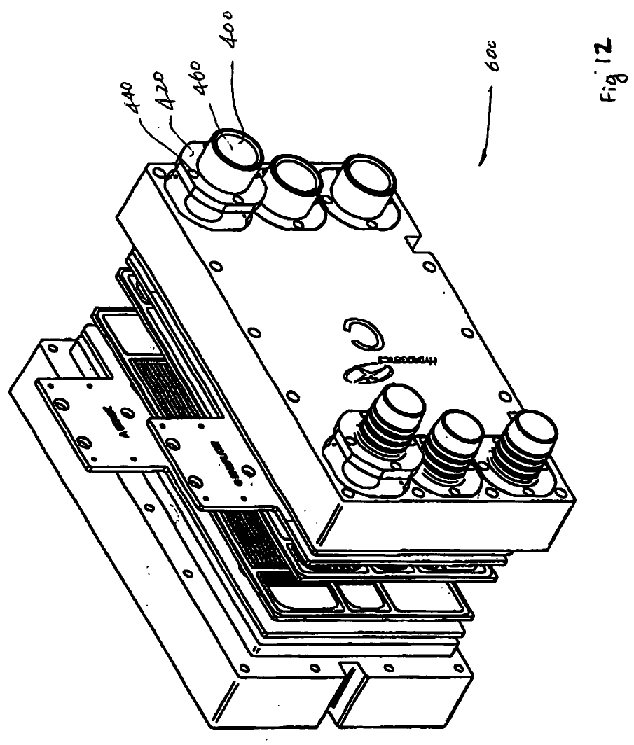

FIG. 12 shows a polarization resistance scan conducted on a sample prepared as described above. The scan gives a good measure of the corrosion rate of a metal residing in a corrosive environment similar to that of a fuel cell. Line 800 is representative of the actual data points, and line 802 is a best fit to the actual data points. The measured polarization resistance was relatively high at 1.26 megohm cm², which corresponds to a very low corrosion rate of less than 1 μm per year.

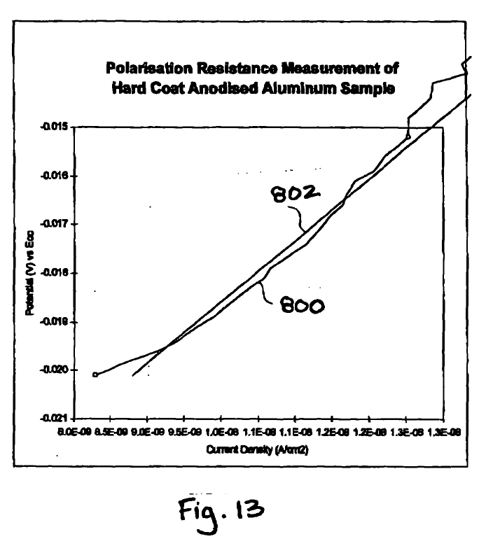

FIG. 13 shows a Tafel scan conducted on a sample prepared as described above. The slope of an anodic portion 804 of the Tafel scan was relatively high, indicating that the coating is passive under anodic conditions. The polarization resistance determined by the Tafel analysis was 5.47 megohm cm², which is comparable to the value obtained in the polarization resistance analysis of 1.26 megohm cm². The estimated corrosion current density is very low at approximately 12 nA cm⁻², which corresponds to a corrosion rate of less than 1 μm per year.

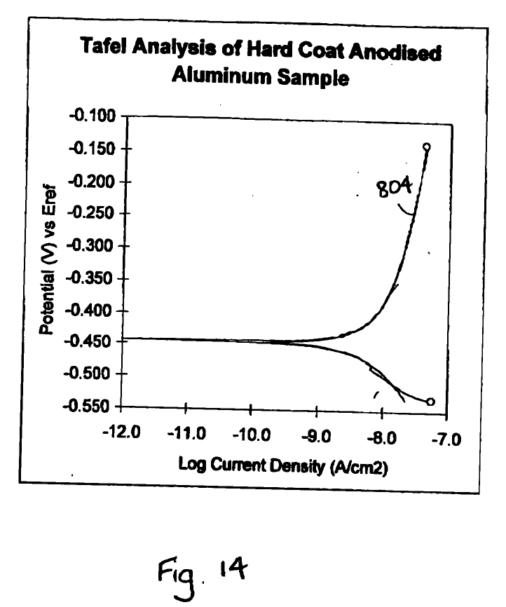

FIG. 14 illustrates an Electrochemical Impedance Spectroscopy (EIS) scan conducted on a sample prepared as described above. The impedance versus frequency plot of the EIS scan indicates that the hard coat anodizing process has produced a coating that possesses good electrical insulating properties. A perfect coating would exhibit a plot of the logarithm of the modulus versus the log of the frequency as a line with slope equal to −1. This slope would correspond to a pure capacitive element (e.g., a perfectly insulating coating). Although the slope of the log modulus versus log frequency plot is roughly −0.5, the plot also suggests that the electrochemical system exhibits two time constants. Presumably, one of the tim constants is du to th solution double layer, while the oth r time constant would be due to the very low porosity of the hard coat anodized coating.

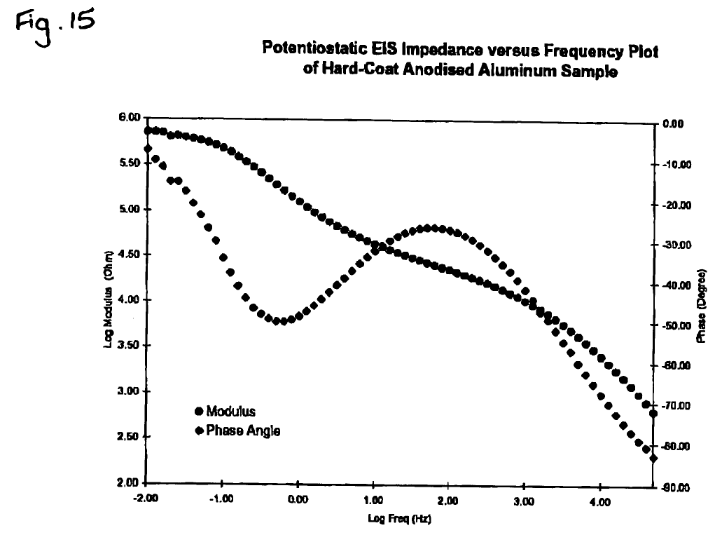

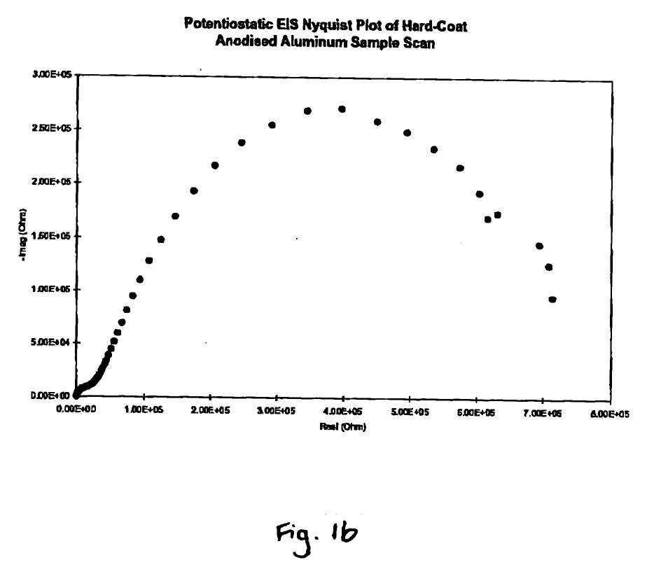

FIG. 15 illustrates a Potentiostatic EIS Nyquist plot conducted on a sample prepared as described above. The Nyquist plot of the EIS data also indicates that the system exhibits two time constants. There is no contribution of a constant phase element in the Nyquist plot, which suggests that there are no diffusion effects to and from the substrate and through any pores. Therefore, it is expected that the sample would exhibit good corrosion resistance and good electrical isolation from the process streams.

Having illustrated and described the principles of the invention in a preferred embodiment, it should be appreciated to those skilled in the art that the invention can be modified in arrangement and detail without departure from such principles. We claim all modifications coming within the scope of the following claims.

1. An end plate for an electrochemical cell, comprising:
a) a metal plate having a manifold region with a connection port to permit the passage of a fluid therethrough; and
b) a corrosion resistant coating applied to at least a portion of the manifold region including the connection port.

2. An end plate according to claim 1, wherein the connection port is defined by at least one wall and the corrosion resistant coating is applied to the at least one wall.

3. An end plate as claimed in claim 2, wherein the metal plate is made from a metal selected from the group consisting of aluminum and aluminum alloys.

4. An end plate as claimed in claim 3, wherein the corrosion resistant coating is an anodized aluminum coating.

5. An end plate as claimed in claim 4, wherein the corrosion resistant coating is a hard coat anodized aluminum coating.

6. An end plate as claimed in claim 5, wherein the hard coat anodized aluminum coating has a plurality of pores and is treated to seal at least a portion of the pores.

7. An end plate as claimed in claim 6, wherein the hard coat anodized aluminum coating has a thickness of between about 3 μm to about 130 μm.

8. An end plate as claimed in claim 2, wherein the corrosion resistant coating is a conformal coating.

9. An end plate as claimed in claim 8, wherein the conformal coating is a polymer material selected from th group consisting of silicone r sins, acrylic resins, polyurethane resins, epoxy resins, polytetrafluoroethylene, polyvinylidenefluoride, and poly para-xylene.

10. An end plate as claimed in claim 9, wherein the conformal coating is poly para-xylene.

11. An end plate as claimed in claim 10, wherein the conformal coating has a thickness of between about 0.05 μm to about 150 μm.

12. An end plate as claimed in claim 2, wherein the corrosion resistant coating is applied to essentially all of the exposed surfaces of the manifold region.

13. An end plate as claimed in claim 2, wherein the corrosion resistant coating is applied to essentially all of the exposed surfaces of the end plate.

14. A method of producing an end plate for an electrochemical cell. comprising:
a) providing a metal plate having a manifold region with a connection port to permit the passage of a fluid therethrough; and
b) applying a corrosion resistant coating to at least a portion of the manifold region including the connection port.

15. A method according to claim 14, wherein the connection port is defined by at least one wall and the corrosion resistant coating is applied to the at least the wall.

16. A method as claimed in claim 15, further comprising forming the metal plate from one of aluminum and an aluminum alloy.

17. A method as claimed in claim 16, further comprising selecting an anodized aluminum coating as the corrosion resistant coating.

18. A method as claimed in claim 17, wh rein step (b) is performed by subjecting at least a portion of the manifold r gion to a process selected from the group consisting of chromic acid anodizing, low voltage chromic anodizing, anodizing in a non-chromic acid electrolyte, sulfuric acid anodizing and hard coat anodizing to apply the anodized aluminum coating.

19. A method as claimed in claim 18, wherein step (b) is performed by subjecting at least a portion of the manifold region to a hard coat anodizing process to apply a hard coat anodized aluminum coating having a plurality of pores.

20. A method as claimed in claim 19, further comprising the step of subjecting at least a portion of the manifold region to a sealing treatment after step (b) to seal at least a portion of the pores.

21. A method as claimed in claim 20, wherein the sealing treatment is selected from the group consisting of dichromate sealing, potassium dichromate sealing, boiling water sealing, and triethanolamine sealing.

22. A method as claimed in claim 17, further comprising the step of subjecting the manifold region to a mechanical process prior to step (b) to remove sharp edges and/or to round corners.

23. A method as claimed in claim 22, wherein the mechanical process comprises radiusing.

24. A method as claimed in claim 17, wherein step (b) is practiced to apply an anodized aluminum coating having a thickness of between about 3 μm to about 130 μm.

25. A method as claimed in claim 15, further comprising selecting a conformal coating as the corrosion resistant coating.

26. A method as claimed in claim 25, wherein the conformal coating is a polymer material selected from the group consisting of silicone resins, acrylic resins, polyurethane resins, poxy r sins, polytetrafluoroethylene, polyvinyliden fluoride, and poly para-xylene.

27. A method as claimed in claim 26, wherein the conformal coating is poly para-xylene.

28. A method as claimed in claim 27, wherein step (b) is performed by subjecting at least a portion of the at least one manifold region to a vacuum deposition process to apply the poly para-xylylene.

29. A method as claimed in claim 25, further comprising the step of subjecting the manifold region to a mechanical process prior to step (b) to remove sharp edges and/or to round corners.

30. A method as claimed in claim 29, wherein the mechanical process comprises radiusing.

31. A method as claimed in claim 25, wherein step (b) is practiced to apply a conformal coating having a thickness of between about 0.05 μm to about 150 μm.

32. A method as claimed in claim 15, wherein step (b) is practic d to apply the corrosion resistant coating to essentially all of the exposed surfaces of the manifold region.

33. A method as claimed in claim 15, wherein step (b) is practiced to apply the corrosion resistant coating to essentially all of the exposed surfaces of the end plate.
